(19) United States
(12) Patent Application Publication
(10) Pub. No.: US 2024/0312174 A1
(43) Pub. Date: Sep. 19, 2024

(54) METHOD AND SYSTEM FOR DETERMINING A PROPAGATION PATH OF FIRE OR SMOKE

(71) Applicant: L&T TECHNOLOGY SERVICES LIMITED, Chennai (IN)

(72) Inventors: PRADEEP ARJUN SAVANUR, Mysore (IN); VIGNESHWAR KARUNANITHI, Salem (IN)

(21) Appl. No.: 18/414,506

(22) Filed: Jan. 17, 2024

(30) Foreign Application Priority Data
Mar. 17, 2023 (IN) 202341018213

(51) Int. Cl. G06V 10/25; G06T 5/20; G06T 7/11; G06T 7/20; G06V 10/764; G08B 17/10

(52) U.S. Cl. CPC G06V 10/25; G06T 5/20; G06T 7/11; G06T 7/20; G06V 10/764; G08B 17/10; G06V 2201/07

(57) ABSTRACT

A method and system of determining a propagation path of fire or smoke is disclosed that includes receiving, by a processor, a plurality of image frames captured by an imaging device. A plurality of regions of interests are determined based on determination of one or more object and masks based on motion detection and color segmentation. A class for each of the plurality of regions of interest is determined to be one of a fire class or a smoke class using a deep learning model. Further, a direction of propagation path of fire or smoke based on a displacement in coordinates of a centroid of each of the plurality of regions of interest is determined in each of the plurality of image frames. An output is rendered based on the detection of the class along with the direction of propagation path of fire or smoke.

### TECHNICAL FIELD

This disclosure relates generally to image processing, and more particularly to a system and a method for determining a propagation path of fire or smoke.

### BACKGROUND

Fire safety system is an integral part of any building infrastructure. In conventional fire safety systems, fire safety is achieved through the strategic placement of fire and smoke detectors on the ceiling of buildings. The fire and smoke detectors may include one or more heat detectors, smoke detectors, or carbon monoxide detectors. These detectors have different working principles like ionization and photometry. The fire safety system triggers an alarm when the detected values by the detectors breach a predefined threshold value. Thus, the detectors of conventional systems being point measurement devices, only trigger the alarm if the amount of heat or smoke at the point of placement of the detectors is more than the threshold value. This causes latency in detection which could lead to fatal consequences. In places such as industries and warehouses, where the ceiling height is high, there is a possibility that the smoke may lose momentum before it reaches the ceiling, forming a layer and preventing further smoke to rise due to stratification. Thus, preventing the detection of fire and smoke. Thus, conventional fire safety systems are predominantly point-based measurement devices and hence inherently have many drawbacks such as latency in detection, false alarms, and constricted field of view of detection. Also, such conventional fire safety systems are ineffective in high-ceiling buildings like industries.

Therefore, there is a requirement for an efficient and reliable fire safety system to detect fire without latency for a timely evacuation or preventive action to be taken.

### SUMMARY OF THE INVENTION

In an embodiment, a method of determining a propagation path of fire or smoke is provided. The method may include receiving a plurality of image frames by a processor. In an embodiment, the plurality of image frames may be captured by an imaging device. The method may further include determining a plurality of regions of interest (ROIs) in each of the plurality of image frames based on detection of one or more objects in each of the plurality of image frames. The processor may further determine one or more masks based on motion detection and color segmentation for each of the one or more objects in each of the plurality of image frames for determining the plurality of ROIs based on the one or more masks. A class for each of the plurality of ROIs may be determined using a deep learning model. In an embodiment, the class determined may be a fire class or a smoke class. In an embodiment, the deep learning model may be trained based on training data corresponding to fire and smoke. The method may further include determining a direction of propagation path of fire or smoke based on a displacement in coordinates of a centroid of each of the plurality of ROIs in each of the plurality of image frames. In an embodiment, the displacement may be computed for each of the plurality of frames in a time sequence of occurrence of the plurality of frames. Accordingly, the processor may render an output based on the detection of the class along with the direction of propagation path of fire or smoke.

In another embodiment, a system of determining a propagation path of fire or smoke comprising one or more processors and a memory is provided. The memory may store a plurality of processor-executable instructions which upon execution cause one or more processors to receive a plurality of image frames captured by an imaging device. The processors may determine a plurality of regions of interest (ROIs) in each of the plurality of image frames based on detection of one or more objects in each of the plurality of image frames. The processors may further determine one or more masks based on motion detection and color segmentation for each of the one or more objects in each of the plurality of image frames for determining the plurality of ROIs based on the one or more masks. The processors may further determine a class for each of the plurality of ROI using a deep learning model. In an embodiment, the class may be a fire class or a smoke class. In an embodiment, the deep learning model may be trained based on training data corresponding to fire and smoke. The processors may be further configured to determine a direction of the propagation path of fire or smoke based on a displacement in coordinates of a centroid of each of the plurality of ROI in each of the plurality of image frames. In an embodiment, the displacement may be computed for each of the plurality of frames in a time sequence of occurrence of the plurality of frames. The processors may be configured to render an output based on the detection of the class along with the direction of the propagation path of fire or smoke.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of a fire/smoke propagation path determination (PPD) system, in accordance with an embodiment of the present disclosure.

FIG. 2 illustrates a functional block diagram of the fire/smoke PPD device, in accordance with an embodiment of the present disclosure.

FIG. 3A depicts an exemplary captured frame of a FOV by the fire/smoke detection unit, in accordance with an embodiment of the present disclosure.

FIG. 3B depicts contour or boundary detection in a processed frame of the captured frame of FIG. 3A, in accordance with an embodiment of the present disclosure.

FIG. 3C depicts one or more bounding boxes rendered in the captured frame, in accordance with an embodiment of the present disclosure.

FIG. 3D depicts a bounding box rendered on a captured frame along with confidence score, in accordance with an embodiment of the present disclosure.

FIG. 4 depicts image frames captured for a FOV with bounding boxes based on detection of fire and/or smoke, in accordance with an embodiment of the present disclosure.

FIG. 5 illustrates a flowchart depicting methodology of determining a propagation path of fire or smoke, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims. Additional illustrative embodiments are listed.

Detection of fire or smoke is an essential and critical safety measure for any commercial or residential building. However, conventional fire detection systems trigger a warning alarm only based on point-based detection of fire or smoke. Therefore, latency in detection of a fire or smoke from the time of initiation of a fire, may cause a delay in initiation of preventive actions such as evacuation. Further, the conventional fire detection systems do not provide any information about the propagation or intensity of fire or smoke in order to plan evacuation to a safe area. The present disclosure provides a fire/smoke detection system that determines a path of propagation of fire/smoke in order for the authorities to plan evacuation to safe areas where the chance of propagation of fire or smoke is less.

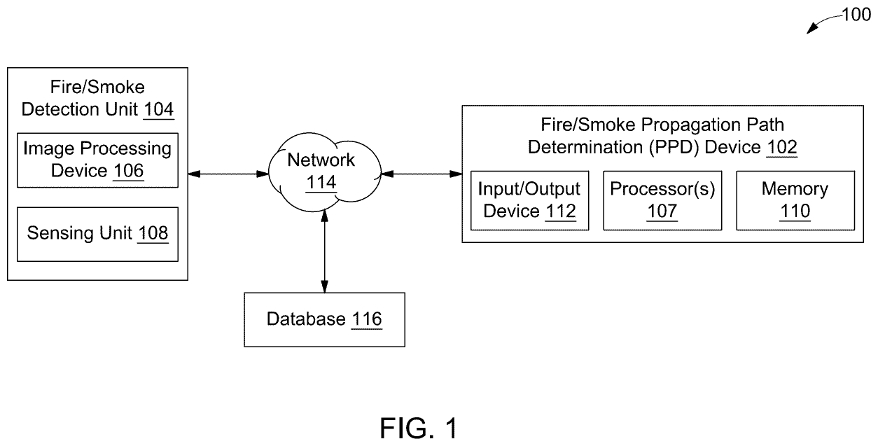

The present disclosure provides methods and systems for determining propagation path of fire or smoke. FIG. 1 is a block diagram of a fire/smoke propagation path determination (PPD) system 100 to determine propagation path of a fire or smoke, in accordance with an embodiment of the present disclosure. The fire/smoke propagation path determination (PPD) system 100 may include a fire/smoke propagation path determination (PPD) device 102 comprising one or more processors 107, a memory 110 and an input/output device 112. The fire/smoke PPD device 102 may be communicably connected to a fire/smoke detection unit 104 and a database 116 through a network 114. In an embodiment, the database 116 may be enabled in a cloud or a physical database comprising training data such as images of varying classes of fire and/or smoke. In an embodiment, database 116 may be, but not limited to, a third party paid or open-source databases.

In an embodiment, the fire/smoke PPD device 102 may be communicatively coupled to the fire/smoke detection unit 104 through a wireless or wired communication network 114. In an embodiment, the fire/smoke PPD device 102 may receive real time image frames of a field of view (FOV) being captured by an image processing device 106 of the fire/smoke detection unit 104 through the network 114.

In an embodiment, the fire/smoke PPD device 102 may be a computing system, including but not limited to, a smart phone, a laptop computer, a desktop computer, a notebook, a workstation, a portable computer, a personal digital assistant, a handheld or a mobile device. In an embodiment, the fire/smoke PPD device 102 may be enabled as an application or a software installed or enables in a computing device.

The fire/smoke PPD device 102 may include one or more processor(s) 107, a memory 110 and an input/output device 112. In an embodiment, examples of processor(s) 107 may include, but are not limited to, an Intel® Itanium® or Itanium 2 processor(s), or AMD® Opteron® or Athlon MP® processor(s), Motorola® lines of processors, Nvidia®, FortiSOC™ system on chip processors or other future processors. In an embodiment, the processor 107 may be, but not limited to, Nvidia® Jetson Nano Developer kit. The memory 110 may store instructions that, when executed by the processor 107, cause the processor 107 to determine a propagation path of fire or smoke, as discussed in greater detail below. The memory 110 may be a non-volatile memory or a volatile memory. Examples of non-volatile memory may include, but are not limited to a flash memory, a Read Only Memory (ROM), a Programmable ROM (PROM), Erasable PROM (EPROM), and Electrically EPROM (EEPROM) memory. Examples of volatile memory may include but are not limited to Dynamic Random Access Memory (DRAM), and Static Random-Access memory (SRAM).

In an embodiment, the communication network 114 may be a wired or a wireless network or a combination thereof. The network 114 can be implemented as one of the different types of networks, such as but not limited to, ethernetIP network, intranet, local area network (LAN), wide area network (WAN), the internet, Wi-Fi, LTE network, CDMA network, and the like. Further, the network 114 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 114 can include a variety of network devices, including routers, bridges, servers, computing devices, storage devices, and the like.

In an embodiment, the input/output device 112 of the fire/smoke PPD device 102 may include a variety of interfaces, for example, interfaces for data input and output devices, storage devices, and the like. The input/output device 112 may facilitate communication of the fire/smoke PPD device 102 and may provide a communication pathway for one or more components of the system 100. Examples of such components include, but are not limited to, processor(s) 107 and memory 110.

Further, in an embodiment, the input/output device 112 may include, but not limited to a camera, a mic, a speaker, a handheld device i.e., phone, tablet, etc., Human Machine Interface (HMI), etc. The input/output device 112 may be configured to receive an input from the database 116 and the fire/smoke detection unit 104. In an embodiment, the input/output device 112 may receive one or more inputs from the database 116. In an embodiment, the fire/smoke PPD device 102 may determine or estimate a propagation path of fire or smoke based on the inputs received from the fire/smoke detection unit 104.

In an embodiment, the image processing device 106 of the fire/smoke detection unit 104 may include one or more imaging sensors that may continuously capture image frames of a field of view (FOV) of the one or more imaging sensors. In an embodiment, the imaging sensors may be, but not limited to, Raspberry pi camera v2 or v3. In an embodiment, the image processing device 106 may pre-process the image frames to reduce noise using one or more techniques such as, but not limited to, gaussian blur, etc. to remove any residual noise in the frames before being transmitted to the fire/smoke PPD device 102. In an embodiment, the image processing device 106 may be implemented on, but not limited to, Nvidia® Jetson Nano Developer kit.

In an embodiment, the fire/smoke detection unit 104 may include a sensing unit 108 which may include one or more sensors such as, but not limited to, thermal sensors, gas sensors, anemometer, etc. In an embodiment, the sensing unit 108 may provide the sensed data to the fire/smoke PPD device 102 for the fire/smoke PPD device 102 to accurately determine a path of propagation of fire and/or smoke and accordingly provide an alert and/or an alarm including a visual notification or an audio notification. In an embodiment, the fire/smoke detection unit 104 may be integrated into the fire/smoke PPD device 102 as a single device.

In an embodiment, the fire/smoke PPD device 102 may receive the plurality of frames captured and transmitted by the image processing device 106 to determine one or more region of interests based on detection of one or more objects in each of the image frames received using object detection methodologies. In an embodiment, the fire/smoke PPD device 102 may further process each of the image frames for motion detection and color segmentation of the one or more objects. Since, fire and/or smoke have a tendency to grow and spread which in turn may cause motion. Accordingly, motion detection may be implemented using one or more motion detection techniques such as, but not limited to, background subtraction, pixel matching or frame referencing, etc. In an embodiment, based on motion detection, the fire/smoke PPD device 102 may detect an activity of an object by detecting a change in the position of an object relative to its surroundings or a change in the surroundings relative to an object in a series of frames captured. Accordingly, any change detected corresponding to one or more objects between frames is regarded as ‘motion detection’. Further, in order to mask out moving objects like people, vehicles, and other objects other than fire and/or smoke, color segmentation methodology may be implemented to determine objects pertaining to fire and smoke colors. Further, the fire/smoke PPD device 102 may determine objects corresponding to fire and/or smoke based on color segmentation which may compare the color feature of each pixel with the color features of surrounding pixels or a trained color classifier corresponding to fire class or smoke class to segment each frame into color regions. The fire/smoke PPD device 102 may implement the mask to use color segmentation to separate color objects of interest from background clutter. Accordingly, the mask of fire/smoke PPD device 102 may determine one or more region of interest (ROI) by determining contours or boundary coordinates of the one or more objects which correspond to fire and/or smoke classes. In an embodiment, the fire/smoke PPD device 102 may remove imperfections in the created mask using one or more morphological operations. Further, based on the usage of the masks, the fire/smoke PPD device 102 may detect fire and/or smoke even when it may be hidden from the FOV of the imaging processing device 106 due to the presence of an object. Accordingly, the fire/smoke PPD device 102 may determine one or more region of interests (ROIs) in each of the frames based on the one or more masks. The fire/smoke PPD device 102 may enable contour extraction methodology to determine contours of fire and/or smoke and determine the ROIs.

In an embodiment, the ROIs determined may be fed as input to a neural network pipeline implementing a neural network architecture such as, but not limited to, Yolov5, etc. In an embodiment, the neural network may be trained based on a training dataset of images corresponding to fire class and smoke class. In an embodiment, based on the processing of the frames using the neural network architecture, the fire/smoke PPD device 102 may determine a class of each of the ROIs detected in each of the frames to be one of a fire class or a smoke class. In an embodiment, the fire/smoke PPD device 102 may determine a confidence value of each of the ROIs depicting an intensity of the fire and/or smoke detected using the neural network architecture. Further, the fire/smoke PPD device 102 may also determine a centroid of each of the ROIs determined. Accordingly, the fire/smoke PPD device 102 may determine a direction of propagation path of fire or smoke based on determination of displacement of the centroid of each of the ROIs corresponding to fire or smoke class in each of the plurality of frames in a time sequence of occurrence of the plurality of frames. Further, the fire/smoke PPD device 102 may render on a display of the input/output device 112 a bounding box corresponding to each of the ROIs detected in each frame, the corresponding confidence value and display a path of propagation of each of the ROIs depicting a direction in which the fire and/or smoke detected may propagate. In an embodiment, the direction of propagation may be depicted as line connecting the centroids of each of the ROIs detected in a time sequence of occurrence of the plurality of frames. In an embodiment, the fire/smoke PPD device 102 may render the bounding box, the confidence value and the direction of propagation may be displayed as augmented reality over the image frames being captured by the image processing device 106.

Accordingly, the fire/smoke PPD device 102 may provide visual notification or alert by displaying the bounding box, confidence values and a direction of propagation for each ROI in form of virtual augmented information being augmented onto a video of a real environment which may be used to give instructions, draw users' attention, or support the understanding of 3D shapes and dimensions. In an embodiment, the virtual augmented information may be superimposed with real environment such that it is bright and distinguishable from the real environment. In an embodiment, along with the visual notification, the fire/smoke PPD device 102 may provide an audio notification in form of sirens or alarms based on detection of fire and/or smoke.

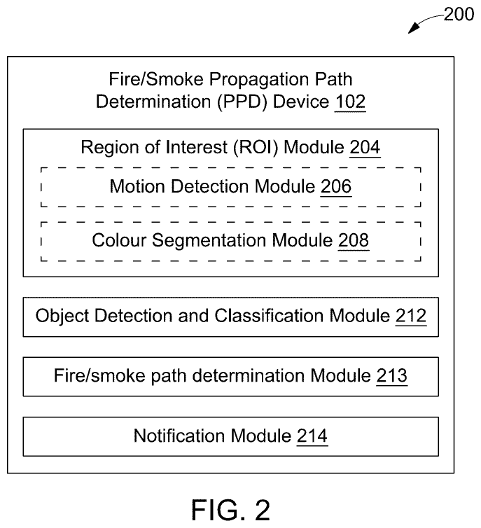

FIG. 2 illustrates a functional block diagram of the fire/smoke PPD device 102, in accordance with an embodiment of the present disclosure. Referring now to FIG. 2, the functional block diagram 200 of the fire/smoke PPD device 102 comprises a region of interest (ROI) determination module 204, a motion detection module 206, a color segmentation module 208, a masking module 210, an object detection and classification module 212, a fire/smoke path determination module 213 and a notification module 214.

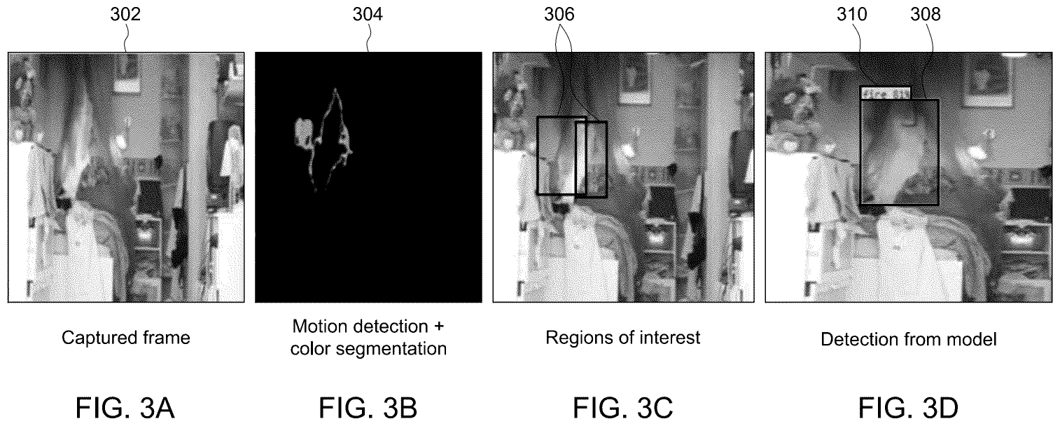

The ROI module 204 may determine one or more region of interest with respect to creation of one or more masks generated based on motion detection and color segmentation for each of the frames. The ROI module 204 may receive image frames of a FOV being captured by the fire/smoke detection unit 104. FIG. 3A depicts an exemplary captured frame 302 of a FOV by the fire/smoke detection unit 104, in accordance with an embodiment of the present disclosure. The ROI module 204 may detect one or more objects in each image frame based using object detection techniques such as, but not limited to, background subtraction, static methods, time difference, optical flow, etc. Since, fire and smoke tend to grow and spread, accordingly, they may be differentiated based on the motion detection and color segmentation of the frames subsequent to object detection.

In an embodiment, the objects may include objects which may be moving and which may be stationary. Also, in an embodiment, one or more object may be of a color of fire or smoke. Accordingly, the ROI module 204 may include a motion detection module 206 and a color segmentation module 208 to determine contours or boundaries of one or more objects which are determined to be moving based on motion detection techniques and which are determined to have color of that of fire or smoke based on color segmentation techniques respectively as ROI information. FIG. 3B depicts contour or boundary detection in a processed frame of the captured frame of FIG. 3A, in accordance with an embodiment of the present disclosure. Based on a processing of the captured frame 302 using the one or more masks, a processed frame 304 may be determined ROI information and may output contour or boundary of objects which may be detected based on motion detection and color segmentation corresponding to fire and/or smoke. FIG. 3C depicts one or more bounding boxes rendered in the captured frame, in accordance with an embodiment of the present disclosure. The ROI module 204 may output or render a bounding box 306 enclosing the contour or boundary of objects which may be detected based on motion detection and color segmentation corresponding to fire and/or smoke on the captured frame as shown in FIG. 3C. In an embodiment, the ROIs 306 may be rendered as an augmented reality displayed in real time based on the detection of objects corresponding to fire and/or smoke.

The object detection and classification module 212 may utilize the ROI information outputted by the ROI module 204 and utilize a deep learning model to determine one or more bounding boxes corresponding to the detected ROIs corresponding to fire and/or smoke. In an embodiment, the deep learning model may be trained based on a custom dataset comprising images of fire and smoke corresponding to a fire class and a smoke class respectively. In an embodiment, the classification module may determine the bounding box for the ROIs and also localizes the objects corresponding to fire and/or smoke by classifying them as a fire class or a smoke class based on the classification output of the deep learning algorithm. Further, the classification module may determine a confidence value for each bounding box based on accuracy of mapping of an ROI to a fire class or a smoke class. In an embodiment, the deep learning model utilized may be selected from, but not limited to, YOLOv5 architecture which may be tested on validation dataset to be accurate up to 90% mAP with average precision of 85% for fire class and 94% precision for smoke class.

FIG. 3D depicts a bounding box rendered on a captured frame along with a confidence score, in accordance with an embodiment of the present disclosure. A bounding box 308 is determined by the classification module 212 using the deep learning techniques and a confidence score 310 corresponding to the bounding box 308 depicting the probability or surety of detection of fire and/or smoke in the captured frame 302.

In an embodiment, the bounding boxes 308 may be rectangular or square boxes outlining the ROIs 306 corresponding to fire and/or smoke. In an embodiment, based on an increase or decrease of fire and/or smoke which may be captured in subsequent image frames, the bounding boxes may be rendered such that they increase or decrease in size depicting the increase or decrease of fire and/or smoke.

The fire/smoke path determination module 213 may determine a centroid of each bounding box in each image frame. Further, a displacement of the centroid of each bounding box may be determined for each frame captured in a time sequence of occurrence of the plurality of frames. Based on the determined displacement a path of propagation of fire and/or smoke and a rate of propagation of fire and/or smoke may be determined. In an embodiment, the displacement in coordinates of the centroid in consecutive frames is determined based on a Kalman filter. In an embodiment, the sensing unit 108 of the fire/smoke detection unit 104 may include an anemometer in order to measure a speed or pressure of wind in the area being captured by the image processing device 106. In an embodiment, the rate of propagation and the direction of propagation may be determined by offsetting the measured wind direction, speed and pressure by the anemometer.

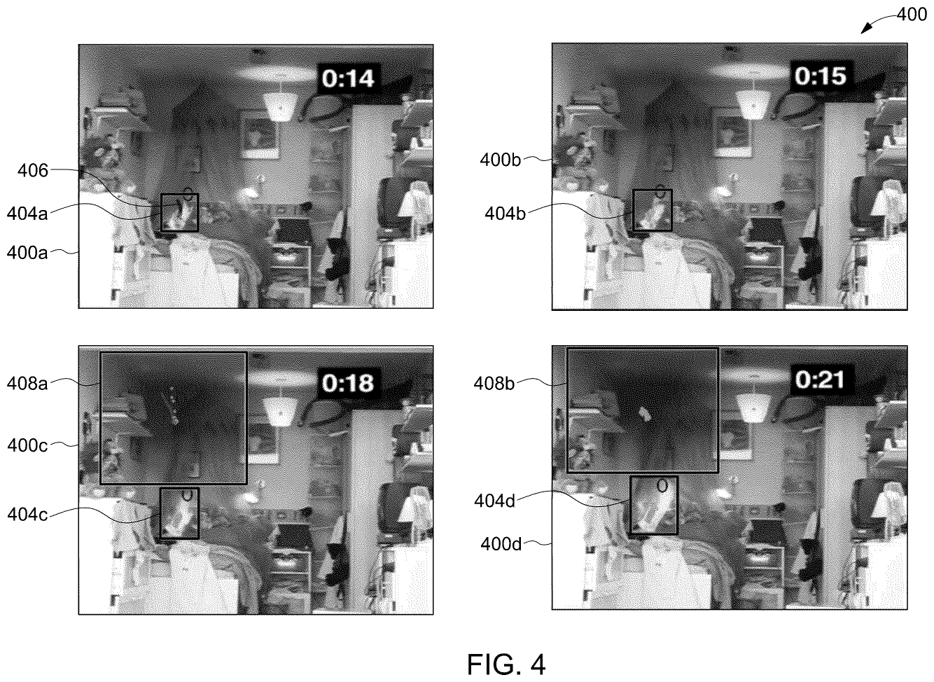

FIG. 4 depicts image frames captured for a FOV with bounding boxes based on detection of fire and/or smoke, in accordance with an embodiment of the present disclosure. FIG. 4 depicts consecutive frames 400a-c captured in a time sequence of occurrence of the frames captured for a scene 400. Each bounding box may be assigned a unique ID based on which the bounding box may be tracked in subsequent image frames. Accordingly, frame 400a being captured depicts detection of bounding boxes 404a and its corresponding centroid or displacement of the centroid 406 corresponding to the bounding box 404a in each subsequence frame captured. Further, frame 400b captured one second later than the time of capturing of frame 400a, the bounding box 404b is seen to increase in size than the bounding box 404a based on increase of the fire detected. In a subsequent frame 400c, a new bounding box 408a may be detected based on detection of smoke along with the bounding box 404c. Furthermore, in frame 400d captured, the bounding boxes 404d and 408b are seen to have increased in size depicting the increase of fire and smoke respectively. In an embodiment, in case a bounding box is not detected in a pre-defined number of subsequent image frames or for a pre-defined time, the bounding box may be deleted along with its unique ID.

In an embodiment, the fire/smoke path determination module 213 may estimate or determine a next coordinate of a centroid of each of the bounding boxes in a subsequent image frame to be captured based on the path of propagation and the rate of propagation of the fire and/or smoke detected in the image frames captured so far. In an embodiment, the fire/smoke PPD device 102 may utilize a 2D Kalman filter in order to update and predict by extrapolating the co-ordinates of the centroid of the bounding boxes determined

$${x}_{k} = [ \begin{matrix}{x}_{k} \\ {y}_{k} \\ {\dot{x}}_{k} \\ {\dot{y}}_{k}\end{matrix} ] = [ \begin{matrix}1 & 0 & Δ t & 0 \\ 0 & 1 & 0 & Δ t \\ 0 & 0 & 1 & 0 \\ 0 & 0 & 0 & 1\end{matrix} ] [ \begin{matrix}{x}_{k - 1} \\ {y}_{k - 1} \\ {\dot{x}}_{k - 1} \\ {\dot{y}}_{k - 1}\end{matrix} ] + [ \begin{matrix}\frac{1}{2} {( Δ t )}^{2} & 0 \\ 0 & \frac{1}{2} {( Δ t )}^{2} \\ Δ t & 0 \\ 0 & Δ t\end{matrix} ] [ \begin{matrix}{\ddot{x}}_{k - 1} \\ {\ddot{y}}_{k - 1}\end{matrix} ]$$

in the previously captured frames and determine or estimate the coordinates of a centroid in the subsequent frames to be captured.

In an embodiment, the fire/smoke path determination module 213 may determine or estimate the coordinates of a centroid in subsequent image frames to be captured by using a Kalman filter which may use a series of centroid coordinates extracted for bounding boxes of fire/smoke observed over time previously, including statistical noise and other inaccuracies, and produces estimates of future centroid. The Kalman filter algorithm has two major steps consisting of 5 equations as given below. The two steps, namely Predict and Update may be performed iteratively on the measurement till an optimal estimate is obtained.

In an embodiment, each centroid coordinates of a bounding box for 10 previously captured frame may be used by the Kalman filter to iteratively predict the coordinates of centroid at time k based on following equation:

Wherein xₖ and yₖ are the coordinates of centroid at time k, that is the current state and xₖ₋₁ and yₖ₋₁ are the coordinates at time k−1, that is the previous state. \dot{x}ₖ, \dot{y}ₖ, \dot{x}ₖ₋₁, \dot{y}ₖ₋₁ are the velocities in x and y directions at time stamps k and k−1. Ideally, by extrapolating this equation, we can predict the next state. Kalman filter may be implemented in two steps, predict and update, which are performed iteratively to estimate the state variables. By estimating the state variables xₖ₊₁ and yₖ₊₁, the propagation path of centroid may be determined in subsequent image frame captured at time k+1, that may depict the propagation of fire or smoke in the subsequent image frame.

The notification module 214 may provide a visual notification and/or an audio notification based on the determination of fire and/or smoke. In an embodiment, based on the determination of the path of propagation and rate of propagation of the fire and/or smoke. The notification module may provide one or more instruction including direction for evacuation of the area. In an embodiment, the fire/smoke detection unit 104 may determine a presence of people based on image processing algorithms and may provide a notification to authorities based on the detection of people for safe evacuation of people in the FOV being captured. In an embodiment, the visual notification may include a flashing of the bounding boxes based on detection of a rate of propagation of fire exceeding a pre-defined threshold. Further, the audio notification may include sounding an alarm or a siren in an area based on detection of the fire and/or smoke.

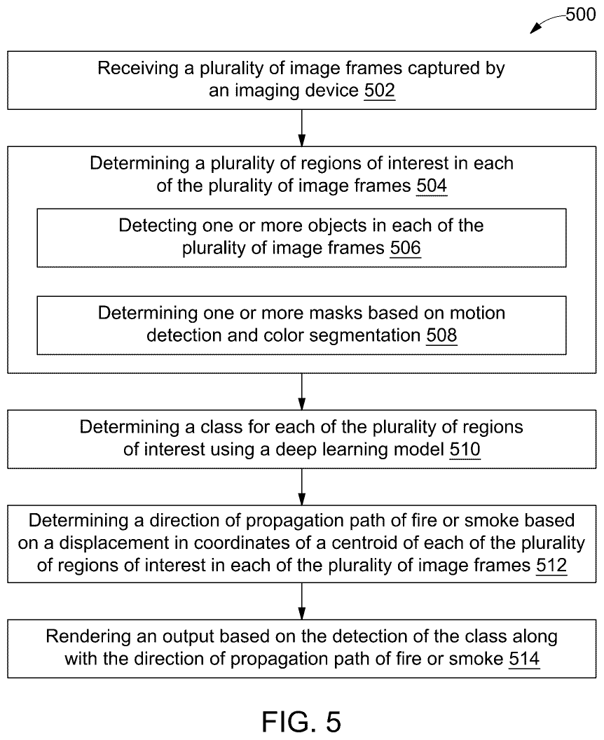

FIG. 5 illustrates a flowchart depicting methodology of determining a propagation path of fire or smoke, in accordance with an embodiment of the present disclosure. At step 502, the processor 107 of the fire/smoke PPD device 102 may receive a plurality of image frames from an imaging device 104. Further, at step 504, a plurality of regions of interest may be determined in each of the plurality of image frames. Further, at step 506, the processor may detect one or more objects in each of the plurality of image frames and at step 508 one or more masks based on motion detection and color segmentation for each of the one or more objects in each of the plurality of image frames may be determined for determination of the plurality of regions of interest based on the one or more masks. At step 510, a class for each of the plurality of regions of interest may be determined using a deep learning model or technique. In an embodiment, the class determined may be a fire class or a smoke class. Further, it may be noted that the deep learning model may be trained based on training data corresponding to training dataset including images of fire and smoke. At step 512, a direction of propagation path of fire or smoke may be determined based on a displacement in coordinates of a centroid of each of the plurality of regions of interest in each of the plurality of image frames. In an embodiment, the displacement may be computed for each of the plurality of frames in a time sequence of occurrence of the plurality of frames. Finally at step 514, an output may be rendered based on the detection of the class along with the direction of propagation path of fire or smoke.

It is intended that the disclosure and examples be considered as exemplary only, with a true scope of disclosed embodiments being indicated by the following claims.

What is claimed is:

1. A method of determining a propagation path of fire or smoke, the method comprising:
receiving, by a processor, a plurality of image frames captured by an imaging device;
determining, by the processor, a plurality of regions of interests (ROIs) in each of the plurality of image frames by:
detecting, by the processor, one or more objects in each of the plurality of image frames; and
determining, by the processor, one or more masks based on motion detection and color segmentation for each of the one or more objects in each of the plurality of image frames;
determining, by the processor, a class for each of the plurality of ROIs using a deep learning model, wherein the class is a fire class or a smoke class, and wherein the deep learning model is trained based on training data corresponding to fire and smoke;
determining, by the processor, a direction of propagation path of fire or smoke based on a displacement in coordinates of a centroid of each of the plurality of ROIs in each of the plurality of image frames, wherein the displacement is computed for each of the plurality of frames in a time sequence of occurrence of the plurality of frames; and
rendering, by the processor, an output based on the detection of the class along with the direction of propagation path of fire or smoke.

2. The method of claim 1, wherein the output comprises displaying a bounding box determined based on the plurality of regions of interests and the class for each of the plurality of ROIs.

3. The method of claim 2, comprises displaying the direction of propagation path of fire or smoke along with the bounding box based on the displacement in the coordinates of the centroid of the plurality of regions of interest in each of the plurality of image frames.

4. The method of claim 3, comprises determining a rate of propagation of fire or smoke determined based on the displacement in the coordinates of the centroid of the plurality of ROIs in each of the plurality of image frames, wherein the displacement in the coordinates of the centroid is determined using a Kalman filter.

5. The method of claim 4, comprises determining a next coordinate of a centroid of each of the plurality ROIs in a subsequent image frame to be captured based on the determination of the direction of propagation path of fire or smoke using the Kalman filter.

6. The method of claim 5, comprises:
generating, by the processor, an alarm based on the detection of the class for each of the plurality of ROIs and the rate of propagation of fire or smoke; and
outputting, by the processor, the predicted next coordinate of the centroid of each of the plurality of ROIs in the subsequent image frame to be captured by displaying an arrow.

7. A system of determining a propagation path of fire or smoke, comprising:
one or more processors;
a memory communicatively coupled to the processors, wherein the memory stores a plurality of processor-executable instructions, which, upon execution, cause the processors to:
receive a plurality of image frames captured by an imaging device;
determine a plurality of regions of interests (ROIs) in each of the plurality of image frames based on:
detection of one or more objects in each of the plurality of image frames; and
determination of one or more masks based on motion detection and color segmentation for each of the one or more objects in each of the plurality of image frames;
determine a class for each of the plurality of ROIs using a deep learning model,
wherein the class is a fire class or a smoke class, and
wherein the deep learning model is trained based on training data corresponding to fire and smoke;
determine a direction of propagation path of fire or smoke based on a displacement in coordinates of a centroid of each of the plurality of ROIs in each of the plurality of image frames,
wherein the displacement is computed for each of the plurality of frames in a time sequence of occurrence of the plurality of frames; and
render an output based on the detection of the class along with the direction of the propagation path of fire or smoke.

8. The system of claim 7, wherein the output comprises displaying a bounding box determined based on the plurality of ROIs and the class for each of the plurality of ROIs.

9. The system of claim 8, wherein the processors are configured to display the direction of propagation path of fire or smoke along with the bounding box based on the displacement in the coordinates of the centroid of the plurality of ROIs in each of the plurality of image frames.

10. The system of claim 9, wherein the processors are configured to determine a rate of propagation of fire or smoke based on the displacement in the coordinates of the centroid of the plurality of ROIs in each of the plurality of image frames, wherein the displacement in coordinates of the centroid is determined using a Kalman filter.

11. The system of claim 10, wherein the processors are configured to determine a next coordinate of a centroid of each of the plurality ROIs in a subsequent image frame to be captured based on the determination of the direction of propagation path of fire or smoke using the Kalman filter.

12. The system of claim 11, wherein the processors are configured to:
generate an alarm based on the detection of the class for each of the plurality of ROIs and the rate of propagation of fire or smoke; and
output the predicted next coordinate of the centroid of each of the plurality of ROIs in the subsequent image frame to be captured by displaying an arrow.

13. A non-transitory computer-readable medium storing computer-executable instructions determining a propagation path of fire of smoke, the computer-executable instructions configured for:
receiving a plurality of image frames captured by an imaging device;
determining a plurality of regions of interests (ROIs) in each of the plurality of image frames by:
detecting one or more objects in each of the plurality of image frames; and
determining one or more masks based on motion detection and color segmentation for each of the one or more objects in each of the plurality of image frames;
determining a class for each of the plurality of ROIs using a deep learning model, wherein the class is a fire class or a smoke class, and wherein the deep learning model is trained based on training data corresponding to fire and smoke;
determining a direction of propagation path of fire or smoke based on a displacement in coordinates of a centroid of each of the plurality of ROIs in each of the plurality of image frames,
wherein the displacement is computed for each of the plurality of frames in a time sequence of occurrence of the plurality of frames; and
rendering an output based on the detection of the class along with the direction of propagation path of fire or smoke.

14. The non-transitory computer-readable medium of claim 13, wherein the output comprises displaying a bounding box determined based on the plurality of regions of interests and the class for each of the plurality of ROIs.

15. The non-transitory computer-readable medium of claim 14, wherein the computer-executable instructions are configured for:
displaying the direction of propagation path of fire or smoke along with the bounding box based on the displacement in the coordinates of the centroid of the plurality of regions of interest in each of the plurality of image frames.

16. The non-transitory computer-readable medium of claim 15, wherein the computer-executable instructions are configured for:
determining a rate of propagation of fire or smoke determined based on the displacement in the coordinates of the centroid of the plurality of ROIs in each of the plurality of image frames,
wherein the displacement in the coordinates of the centroid is determined using a Kalman filter.

17. The non-transitory computer-readable medium of claim 16, wherein the computer-executable instructions are configured for:
determining a next coordinate of a centroid of each of the plurality ROIs in a subsequent image frame to be captured based on the determination of the direction of propagation path of fire or smoke using the Kalman filter.

18. The non-transitory computer-readable medium of claim 17, wherein the computer-executable instructions are configured for:
generating an alarm based on the detection of the class for each of the plurality of ROIs and the rate of propagation of fire or smoke; and
outputting the predicted next coordinate of the centroid of each of the plurality of ROIs in the subsequent image frame to be captured by displaying an arrow.
